(19) United States
(12) Patent Application Publication
(10) Pub. No.: US 2006/0232518 A1
(43) Pub. Date: Oct. 19, 2006

(54) Electron emission display and method of controlling the same

(76) Inventors: Chul-Ho Lee, Cheonan-si (KR); Cheol-Hyeon Chang, Yangsan-si (KR)

Correspondence Address: Robert E. Bushnell, Suite 300, 1522 K Street, N.W., Washington, DC, 20005, US

(21) Appl. No.: 11/349,237

(22) Filed: Feb. 8, 2006

(30) Foreign Application Priority Data
Mar. 31, 2005 (KR) 2005-27307

(51) Int. Cl. G09G 3/22; G09G 3/30

(52) U.S. Cl. 345/74.1; 345/76

(57) ABSTRACT

An electron emission display and a method of controlling the same, in which a voltage applied between a cathode electrode and a gate electrode is adjusted according to an image level, includes: a pixel portion having a plurality of electron emission devices formed adjacent to a region where a plurality of data lines intersects a plurality of scan lines; a data driver supplying a data signal corresponding to video data to the plurality of data lines; a scan driver supplying scan signals to the plurality of scan lines in sequence; a power supply supplying power to the data driver and the scan driver; and a voltage level controller controlling a voltage difference between an cathode electrode and a gate electrode of the electron emission device on the basis of an image level corresponding to the video data. With this configuration, a contrast of an image is high in the case of a low image level and a power consumption is limited in the case of a high image level, and an electron emission device is prevented from deterioration.

### CLAIM OF PRIORITY

This application makes reference to, incorporates the same herein, and claims all benefits accruing under 35 U.S.C. §119 from an application for ELECTRON EMISSION DISPLAY AND CONTROL METHOD OF THE SAME earlier filed in the Korean Intellectual Property Office on 31 Mar. 2005 and there duly assigned Serial No. 2005-27307.

### BACKGROUND OF THE INVENTION

1. Field of the Invention

The present invention relates to an electron emission display and a method of controlling the same, and more particularly, to an electron emission display and a method of controlling the same, in which a voltage applied between a cathode electrode and a gate electrode is adjusted according to an image level.

2. Description of the Related Art

An electron emission display includes an electron emission device corresponding to a pixel. The electron emission device has a cathode electrode and a gate electrode, and emits electrons corresponding to voltage applied between the cathode and gate electrode. The emitted electrons are accelerated by voltage applied to the anode electrode and collide with a fluorescent layer, thereby emitting light. In general, the electron emission device is widely classified into two types according to whether a hot cathode type or a cold cathode is used as an electron source. The electron emission device using the cold cathode has various structures such as a field emitter array (FEA), a surface conduction emitter (SCE) structure, a metal-insulator-metal (MIM) structure, a metal-insulator-semiconductor (MIS) structure, a ballistic electron surface emitting (BSE) structure, etc.

The electron emission device having the FEA structure is based on a principle that a material having a low work function or a high β-function is employed as an electron emission source and emits electrons due to an electric field difference in a vacuum. Such an electron emission device having the FEA structure has been developed, which uses a tip structure, a carbon material, or a nano material as the electron emission source.

The electron emission device having the SCE structure includes an electron emission part, wherein a conductive layer is placed on a plate between two electrodes opposite each other and formed with a minute crack or gap, thereby forming the electron emission part. Such an electron emission device is based on a principle that the electron emission part formed by a minute crack or gap emits an electron when electric current due to voltage applied between two electrodes flows through the surface of the conductive layer.

The electron emission device having an MIM or MIS structure includes an electron emission source having a metal-insulator-metal structure or a metal-insulator-semiconductor structure, and based on a principle that electrons are moved and accelerated from the metal or the semiconductor of high electric potential to the metal of low electric potential when a voltage is applied between the metal and the metal or between the metal and the semiconductor, respectively, thereby emitting the electron.

The electron emission device having the BSE structure, is based on a principle that an electron travels without sputtering when the size of a semiconductor is smaller than a mean free path of the electron contained in the semiconductor. Such an electron emission device includes an electron supplying layer made of a metal or a semiconductor and formed on an ohmic electrode, an insulator formed on the electron supplying layer, and a thin metal layer formed on the insulator, so that the electron is emitted when voltage is applied between the ohmic electrode and the thin metal layer.

In the foregoing electron emission displays, the brightness and the contrast of an image can be improved by increasing a voltage difference between the cathode electrode and the gate electrode and increasing the amount of electrons emitted from the cathode electrode of each pixel. However, in the case where the amount of electrons emitted from the cathode electrode is increased, problems arise in that the deterioration of the electron emission device increases and the power consumption of the electron emission display increases. On the other hand, in the case where the amount of electrons emitted from the cathode electrode is decreased by decreasing the voltage difference between the cathode electrode and the gate electrode in order to reduce the deterioration of the electron emission device and the power consumption of the electron emission display, the brightness and the contrast of an image are deteriorated.

### SUMMARY OF THE INVENTION

Accordingly, it is an aspect of the present invention to provide an electron emission display and a method of controlling the same, in when a voltage applied between a cathode electrode and a gate electrode is adjusted according to an image level, so that a contrast of an image is high in the case of a low image level and a power consumption is limited in the case of a high image level, and an electron emission device is prevented from deterioration.

It is another aspect of the present invention to provide an electron emission device and technique thereof, providing easy implementation, cost effectiveness in manufacture and yet efficient in use.

The foregoing and/or other aspects of the present invention are achieved by providing an electron emission display including: a pixel portion including a plurality of electron emission devices formed adjacent to a region where a plurality of data lines intersects a plurality of scan lines; a data driver supplying a data signal corresponding to video data to the plurality of data lines; a scan driver supplying scan signals to the plurality of scan lines in sequence; a power supply supplying power to the data driver and the scan driver; and a voltage level controller controlling a voltage difference between an cathode electrode and a gate electrode of the electron emission device on the basis of an image level corresponding to the video data.

Another aspect of the present invention are achieved by providing an electron emission display including: a pixel portion including a plurality of electron emission devices defined by a plurality of data lines and a plurality of scan lines; a data driver supplying a data signal corresponding to video data to the plurality of data lines; a scan driver supplying scan signals to the plurality of scan lines in sequence; a power supply supplying powers to the data driver and the scan driver; and a voltage level controller controlling a voltage level of the power supplied from the power supply to at least one of the data driver and the scan driver to be varied on the basis of an image level of the video data.

Still another aspect of the present invention are achieved by providing a method of controlling an electron emission display, including operations of: (a) determining an image level of video data; and (b) adjusting a voltage difference between a cathode electrode and a gate electrode of an electron emission device on the basis of the image level.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates an electron emission display according to an embodiment of the present invention;

FIG. 2 is a partial sectional view of a pixel portion employed in the electron emission display according to an embodiment of the present invention;

FIG. 3 is a block diagram of a data driver employed in the electron emission display according to an embodiment of the present invention;

FIG. 4 is a block diagram of a scan driver employed in the electron emission display according to an embodiment of the present invention;

FIG. 5 is a block diagram of a voltage level controller employed in the electron emission display according to an embodiment of the present invention;

FIGS. 6 through 8 show waveforms of a data signal and a scan signal which vary according to an image level when a data line is used as a cathode electrode and a scan line is used as a gate electrode in the electron emission display according to an embodiment of the present invention; and

FIG. 9 is a flowchart of controlling the electron emission display according to an embodiment of the present invention.

### DETAILED DESCRIPTION OF PREFERRED EMBODIMENTS

Hereinafter, preferable embodiments according to the present invention will be described with reference to the accompanying drawings, wherein the preferred embodiments of the present invention are provided to be readily understood by those skilled in the art.

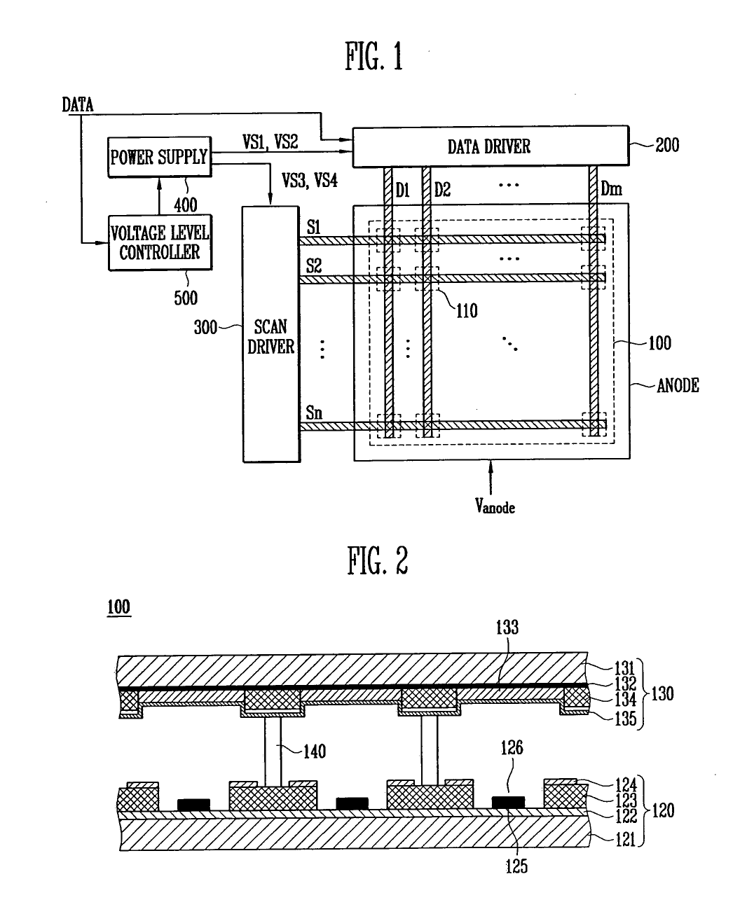

FIG. 1 illustrates an electron emission display according to an embodiment of the present invention. Referring to FIG. 1, an electron emission display according to an embodiment of the present invention includes a pixel portion 100, a data driver 200, a scan driver 300, a power supply 400, and a voltage level controller 500.

The pixel portion 100 includes n scan lines S1, S2, . . . , Sn; m data lines D1, D2, . . . Dm; and an anode electrode ANODE. Here, the scan lines S1, S2, . . . , Sn intersect the data lines D1, D2, . . . , Dm. Referring to FIG. 1, the anode electrode ANODE is formed throughout the pixel portion 100. However, the anode electrode is not limited to that shown in FIG. 1, and may have a plurality of stripe patterns in parallel with the scan lines, a plurality of stripe patterns in parallel with the data lines, or a mesh pattern. In general, the same voltage Vanode is applied to the whole anode electrode regardless of whether the anode electrode has the plurality of stripe patterns or the mesh pattern. Further, an electron emission device 110 has a cathode electrode, a gate electrode and the anode electrode is formed in a region where the scan line intersects the data line. Here, one of the scan line and the data line is employed as the cathode electrode, and the other one is employed as the gate electrode.

The data driver 200 applies a data signal corresponding to input video data DATA to the data lines D1, D2, . . . Dm. In this embodiment, a pulse width modulation (PWM) data driver will be exemplarily described, but not limited to. Alternatively, various data drivers can be used as long as it can control the electron emission device 110 to have an electron emission period corresponding to input video data.

The scan driver 300 applies scan signals to the scan lines S1, S2, . . . , Sn in sequence.

The power supply 400 supplies first power VS1 and second power VS2 to the data driver 200, and supplies third power VS3 and fourth power VS4 to the scan driver 300.

The voltage level controller 500 obtains the image level of the video data, and controls at least one of the voltages applied to the cathode electrode and the gate electrode to vary on the basis of the obtained image level. Here, the image level indicates the brightness of the whole pixel portion 100. For example, the pixel portion 100 is bright at a high image level, but dark at a low image level. The image level can be obtained by the sum of the video data corresponding to one frame. In the case where the image level decreases, the voltage level controller 500 controls the power supply 400 to increase voltage difference between the cathode electrode and the gate electrode when electrons are emitted. On the other hand, in the case where the image level increases, the voltage level controller 500 controls the power supply 400 to decrease the voltage difference between the cathode electrode and the gate electrode when the electrons are emitted. The power supply 400 varies at least one of the powers VS1, VS2, VS3 and VS4 applied to the data and scan drivers 200 and 300 on the basis of the control of the voltage level controller 500. Thus, the data signal outputted from the data driver 200 and/or the scan signal outputted from the scan driver 300 are varied in a voltage level, so that the voltage difference between the cathode electrode and the gate electrode of the electron emission device 110 is varied. On the assumption that the data line is used as the cathode electrode and the scan line is used as the gate electrode, when the image level decreases, the voltage level controller 500 controls the power supply 400 to decrease voltage applied from the data driver 200 to the data line, increase voltage applied from the scan driver 300 to the scan line, or decrease voltage applied from the data driver 200 to the data line and at the same time increase voltage applied from the scan driver 300 to the scan line. Further, when the image level increases, the voltage level controller 500 controls the power supply 400 to increase voltage applied from the data driver 200 to the data line, decrease voltage applied from the scan driver 300 to the scan line, or increase voltage applied from the data driver 200 to the data line and at the same time decrease voltage applied from the scan driver 300 to the scan line. Thus, in the case where the voltage difference between the cathode electrode and the gate electrode increases when the electrons are emitted, the contrast of an image becomes high. Contrarily, in the case where the voltage difference between the cathode electrode and the gate electrode decreases when the electrons are emitted, the power consumption of the electron emission device decreases and the life span thereof increases.

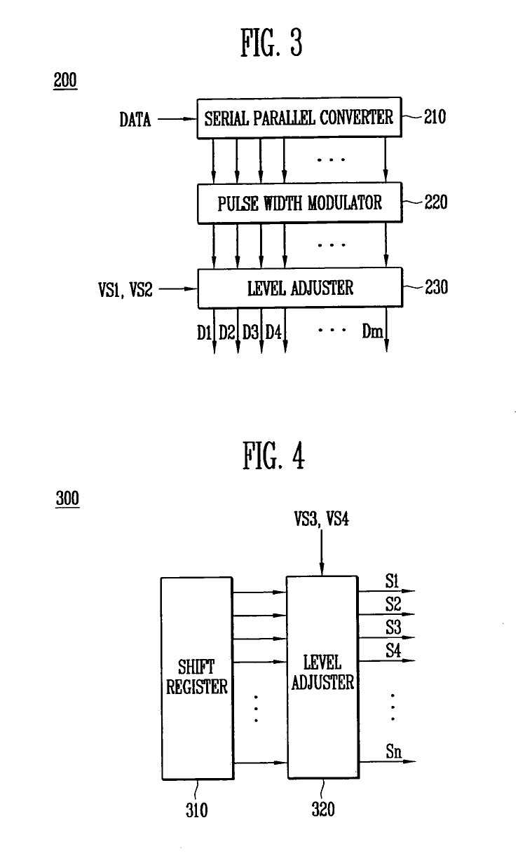

FIG. 2 is a partial sectional view of a pixel portion 100 employed in the electron emission display according to an embodiment of the present invention.

Referring to FIG. 2, the pixel portion includes an electron emission substrate 120, and an image forming substrate 130. Further, the pixel portion additionally includes a spacer 140 to maintain a uniform space between the electron emission substrate 120 and the image forming substrate 130.

The electron emission substrate 120 includes a rear substrate 121, a cathode electrode 122, an insulating layer 123, a gate electrode 124, and an electron emitter 125 so as to emit the electrons corresponding to the voltage difference between the cathode electrode 122 and the gate electrode 124.

The rear substrate 121 includes a glass or silicon substrate by way of example. Particularly, when the electron emitter 125 is formed by rear exposure using carbon nanotube (CNT) paste, a transparent substrate like a glass substrate is preferably used as the rear substrate 121.

The cathode electrode 122 is formed on the rear substrate 121, having a stripe shape. Here, the cathode electrode 122 receives one of a data signal and a scan signal from a data driver and a scan driver. The cathode electrode 122 can be made of a conductive material. Preferably, the cathode electrode 122 is made of a transparent conductive material, e.g., indium tin oxide (ITO), for the same reason as the rear substrate 121.

The insulating layer 123 is formed on the rear substrate 121 and the cathode electrode 122 and electrically insulates the cathode electrode 122 from the gate electrode 124. The insulating layer 123 is made of an insulating material, e.g., a glass material containing a combination of PbO and SiO₂.

The gate electrode 124 is formed on the insulating layer 123, having a stripe shape intersecting the cathode electrode 122. The gate electrode 124 receives either the data signal or the scan signal from the data driver or the scan driver, respectively. The gate electrode 124 is made of metal having good conductivity, e.g. at least one selected from a group including gold (Au), silver (Ag), platinum (Pt), aluminum (Al), chrome (Cr) and alloy thereof. The insulating layer 123 and the gate electrode 124 form at least one first aperture 126 to expose the cathode electrode 122 in a region where the cathode electrode 122 intersects the gate electrode 124.

The electron emitter 125 is formed on and electrically connected to the cathode electrode 122 exposed through the first aperture 126. Here, the electron emitter 125 is preferably made of CNT; a nanotube containing graphite, diamond, diamond-like-carbon or a combination thereof; or a nano-wire containing Si or SiC.

Meanwhile, the image forming substrate 130 includes a front substrate 131, an anode electrode 132, a fluorescent material 133, a light shielding layer 134, and a reflection metal layer 135.

The front substrate 131 is made of a transparent material, e.g., a glass to transmit light from the fluorescent material 133 to the outside.

The anode electrode 132 is made of a transparent material, e.g., an ITO electrode to transmit the light from the fluorescent material 133 to the outside. The anode electrode 132 effectively accelerates the emission of the electrons from the electron emitter 125. For this reason, a high positive voltage (+) is applied to the anode electrode 132, thereby allowing the electrons to be accelerated toward the fluorescent material 133.

The fluorescent material 133 emits light when the electrons emitted from the electron emission substrate 120 collide therewith. The fluorescent material 133 is selectively arranged on the anode electrode 132 at predetermined intervals. For example, a G fluorescent material, i.e., a fluorescent material that emits light for displaying a green color can include ZnS:Cu, Zn₂SiO₄:Mn, ZnS:Cu+Zn₂SiO₄:Mn, Gd₂O₂S:Tb, Y₃AL₅O₁₂:Ce, ZnS:Cu,Al, Y₂O₂S:Tb, ZnO:Zn, ZnS:Cu,Al+In₂O₃, LaPO₄:Ce,Tb,BaO.6Al₂O₃:Mn, (Zn,Cd)S:Ag, (Zn,Cd)S:Cu,Al,ZnS:Cu,Au,Al, Y₃(Al,Ga)₂O₁₂:Tb, Y₂SiO₅:Tb, or LaOCl:Tb. Further, a B fluorescent material, i.e., a fluorescent material that emits light for displaying a blue color can include ZnS:Ag, ZnS:Ag,Al, ZnS:Ag,Ga,Al, ZnS: Ag,Cu,GA,Cl, ZnS:Ag+In₂O₃, Ca₂B₅O₉Cl:Eu²⁺, (Sr,Ca,Ba,Mg)₁₀(PO₄)₆Cl₂:Eu²⁺, Sr₁₀(PO₄)₆C₂:Eu²⁺, BaMgAl₁₆O₂₆:E²⁺, ZnS:Ag containing CoO,Al₂O₃, ZnS:Ag, or Ga. Also, an R fluorescent material, i.e., a fluorescent material that emits light for displaying a red color can include Y₂O₂S:Eu, Zn₃(PO₄)₂:Mn, Y₂O₃:Eu, YVO₄:Eu, (Y,Gd)BO₃:Eu, γ-Zn₃(PO₄)₂:Mn, (ZnCd)S:Ag, (ZnCd)S:Ag+In₂O₃, or Y₂O₂S:Eu containing Fe₂O₃.

The light shielding layer 134 absorbs and shuts out external light, and prevents optical crosstalk. Further, the light shielding layer 134 is arranged between the fluorescent materials 133 at predetermined intervals to enhance the contrast.

The reflection metal layer 135 is formed on the fluorescent material 133 and effectively focuses the electrons emitted from the electron emission substrate 120. Therefore, the light emitted from the fluorescent material 133 due to the electron collision is reflected from the reflection metal layer 135 toward the front substrate 131, thereby promoting reflection efficiency. In the meantime, when the reflection metal layer 135 functions as the anode electrode, the anode electrode may be selectively provided, i.e., inessential.

FIG. 3 is a block diagram of a data driver 200 employed in the electron emission display according to an embodiment of the present invention. As shown in FIG. 3, the data driver 200 includes a serial-parallel converter 210, a pulse width modulator 220, and a level adjustor 230.

The serial-parallel converter 210 converts video data “DATA” inputted in sequence into parallel video data.

The pulse width modulator 220 modulates the pulse width of the parallel video data outputted from the serial-parallel converter 210. For example, the pulse width modulator 220 outputs a data signal having a wide pulse width in the case of the parallel video data corresponding to high gradation, and outputs a data signal having a narrow pulse width in the case of the parallel video data corresponding to low gradation.

The level adjuster 230 adjusts a voltage level of the data signal outputted from the pulse width modulator 220 according to the first power VS1 and the second power VS2 supplied from the power supply 400, and outputs the data signal having the adjusted voltage level to the data lines D1, D2, . . . , Dm. Here, the data signal outputted from the level adjuster 230 has a high voltage level corresponding to the first power VS1, and a low voltage level corresponding to the second power VS2. Thus, the high and/or low voltage level of the data signal vary corresponding to the voltage variation of the first power VS1 and/or the voltage variation of the second power VS2. In the case where the data line D1, D2, . . . , Dm is employed as the cathode electrode, the electron emission device emits the electrons when the data signal has a low level voltage, i.e., a voltage level corresponding the second power VS2. Therefore, the power supply varies the voltage level of the second power VS2, thereby varying the voltage difference between the gate electrode and the cathode electrode when the electrons are emitted. At this time, the voltage level of the first power VS1 may be invariable or may be variable corresponding to the voltage variation of the second power VS2. On the other hand, in the case where the data line D1, D2, . . . , Dm is employed as the gate electrode, the electron emission device emits the electrons when the data signal has a high level voltage, i.e., a voltage level corresponding the first power VS1. Therefore, the power supply varies the voltage level of the first power VS1, thereby varying the voltage difference between the gate electrode and the cathode electrode when the electrons are emitted. At this time, the voltage level of the second power VS2 may be invariable or may be variable corresponding to the voltage variation of the first power VS1.

Meanwhile, in the case where the voltage level controller controls only the voltage level of the scan signal outputted from the scan driver without controlling the voltage level of the data signal outputted from the data driver, the voltage levels of the first power VS1 and the second power VS2 can be invariable, and the data driver can directly output the data signal from the pulse width modulator 220 to the data lines D1, D2, . . . , Dm without the level adjuster 230.

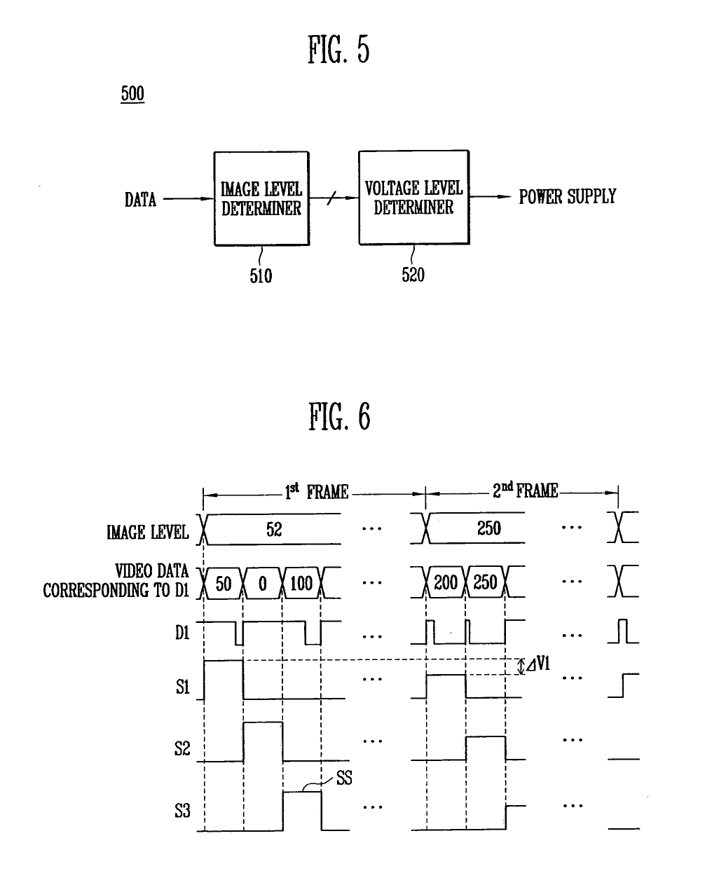

FIG. 4 is a block diagram of a scan driver 300 employed in the electron emission display according to an embodiment of the present invention. Referring to FIG. 4, the scan driver includes a shift register 310 and a level adjuster 320.

The shift register 310 outputs scan signals in sequence.

The level adjuster 320 adjusts the voltage level of the scan signal outputted from the shift register 310 according to the third power VS3 and the fourth power VS4 supplied from the power supply, and outputs the scan signal having the adjusted voltage level to the scan line S1, S2, . . . , Sn. Here, the scan signal outputted from the level adjuster 320 has a high voltage level corresponding to the voltage level of the third power VS3, and a low voltage level corresponding to the voltage level of the fourth power VS4. Thus, the high and/or low level of the scan signal outputted from the level adjuster 320 varies corresponding to the voltage variation of the third power VS3 and/or the voltage variation of the fourth power VS4. In the case where the scan line S1, S2, . . . , Sn is employed as the cathode electrode, the electron emission device emits the electrons when the scan signal has a low level voltage, i.e., a voltage level corresponding the fourth power VS4. Therefore, the power supply varies the voltage level of the fourth power VS4, thereby varying the voltage difference between the gate electrode and the cathode electrode when the electrons are emitted. At this time, the voltage level of the third power VS3 may be invariable or may be variable corresponding to the voltage variation of the fourth power VS4. On the other hand, in the case where the scan line S1, S2, . . . , Sn is employed as the gate electrode, the electron emission device emits the electrons when the data signal has a high level voltage, i.e., a voltage level corresponding the third power VS3. Therefore, the power supply varies the voltage level of the third power VS3, thereby varying the voltage difference between the gate electrode and the cathode electrode when the electrons are emitted. At this time, the voltage level of the fourth power VS4 may be invariable or may be variable corresponding to the voltage variation of the third power VS3.

Meanwhile, in the case where the voltage level controller 500 controls only the voltage level of the data signal outputted from the data driver 200 without controlling the voltage level of the scan signal outputted from the scan driver 300, the voltage levels of the third power VS3 and the fourth power VS4 can be invariable, and the scan driver 300 can directly output the scan signal from the shift register 310 to the scan lines S1, S2, . . . , Sn without the level adjuster 320.

FIG. 5 is a block diagram of a voltage level controller 500 employed in the electron emission display according to an embodiment of the present invention. Referring to FIG. 5, the voltage level controller 500 includes an image level determiner 510 and a voltage level determiner 520.

The image level determiner 510 determines the image level on the basis of video data “DATA” corresponding to one frame. As the video data “DATA” corresponding to one frame includes more high gradation data, the image level becomes low. Contrarily, as the video data “DATA” corresponding to one frame includes more low gradation data, the image level becomes high. For example, the image level determiner 510 obtains the image level using a sum of the video data “DATA” corresponding to one frame. In more detail, the image level determiner 510 obtains a sum of the video data “DATA” corresponding to one frame, and then outputs an upper 8-bit of the obtained sum as the image level.

The voltage level determiner 520 controls the power supply on the basis of the image level outputted from the image level determiner 510. When the image level is high, the voltage level determiner 520 controls the power supply to decrease the voltage difference between the cathode electrode and the gate electrode of the electron emission device. When the image level is low, the voltage level determiner 520 controls the power supply to increase the voltage difference between the cathode electrode and the gate electrode of the electron emission device.

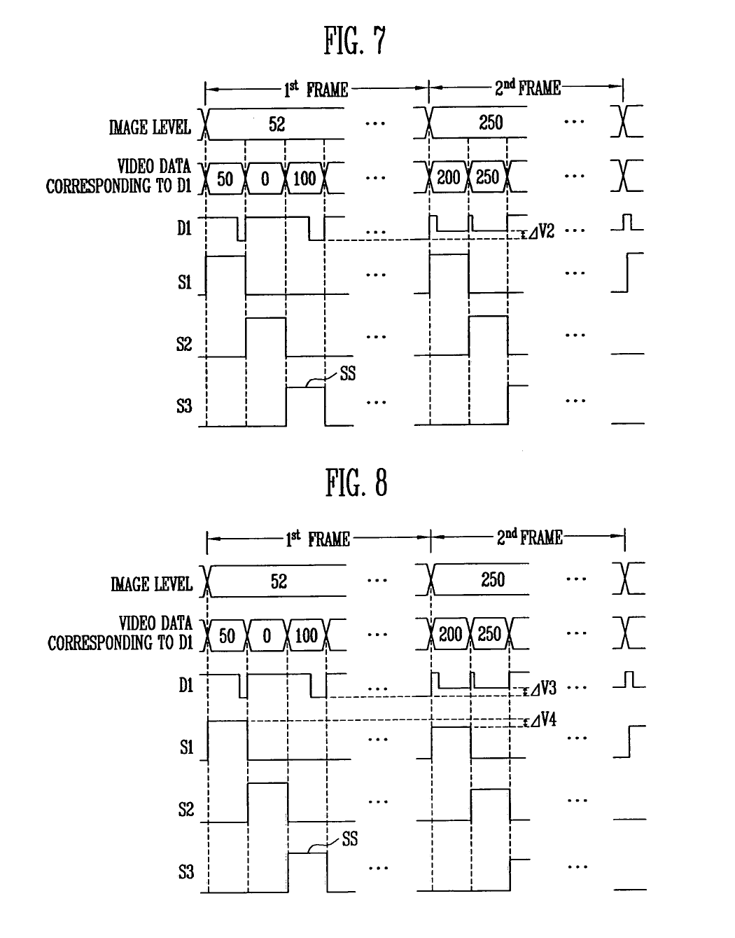

FIGS. 6 through 8 show waveforms of a data signal and a scan signal which vary according to an image level when a data line is used as a cathode electrode and a scan line is used as a gate electrode in the electron emission display according to an embodiment of the present invention.

FIG. 6 illustrates a case that a voltage difference between the gate electrode and the cathode electrode is varied by changing a voltage level applied to the gate electrode. Referring to FIGS. 1 and 6, the data driver 200 receives video data corresponding to the data signal applied to the 1^{st} data line D1, and outputs the data signal corresponding to the video data to the 1^{st} data line D1. The data signal has a pulse width corresponding to the video data. Here, because the data line D1 is used as the cathode electrode, the pulse of the data signal has a low voltage level. Therefore, as the image data gets higher, the pulse width corresponding to the low voltage level becomes wide. Contrarily, if the data line D1 is used as the gate electrode of the electron emission device, the pulse of the data signal has a high voltage level. Meanwhile, the scan driver 300 outputs the scan signals SS to the scan lines S1, S2, . . . , Sn in sequence. Here, because the scan line is used as the gate electrode of the electron emission device, the scan signal SS has a high voltage level. Contrarily, if the scan line is used as the cathode electrode of the electron emission device, the scan signal has a low voltage level. In the electron emission display using the signal waveforms as shown in FIG. 6, the voltage level of the gate electrode, i.e., the voltage level of the scan signal varies as the image level is changed. In more detail, as the image level increases from 52 to 250, that is, as the video data includes more high gradation data, the voltage level of the gate electrode decreases by ΔV1. Then, the voltage difference between the gate electrode and the cathode electrode decreases, and thus the electron emission of each electron emission device decreases, thereby decreasing the brightness of each pixel.

FIG. 7 illustrates a case that a voltage difference between the gate electrode and the cathode electrode is varied by changing a voltage level applied to the cathode electrode. Referring to FIGS. 1 and 7, in the electron emission display, the voltage level of the cathode electrode, i.e., the voltage level of the data signal varies as the image level is changed. In more detail, as the image level increases from 52 to 250, that is, as the video data includes more high gradation data, the voltage level of the cathode electrode increases by ΔV2. Then, the voltage difference between the gate electrode and the cathode electrode decreases, and thus the electron emission of each electron emission device decreases, thereby decreasing the brightness of each pixel. The other signals of FIG. 7 are not different from those of FIG. 6, and therefore repetitive descriptions will be avoided.

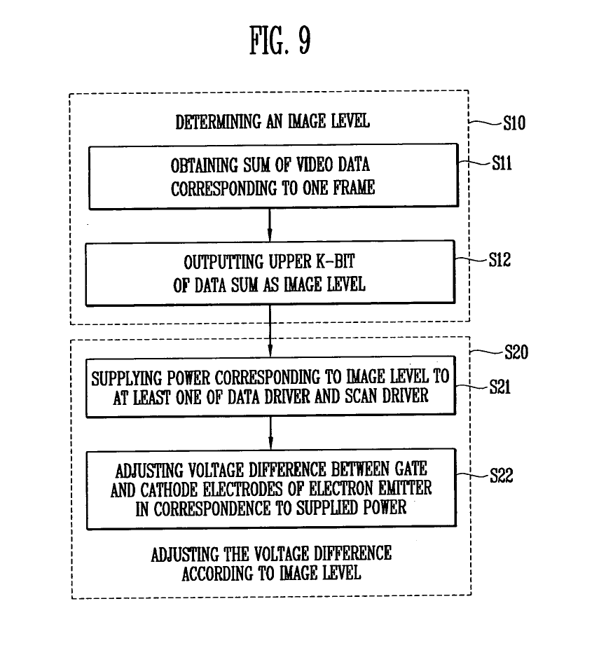

FIG. 8 illustrates a case that a voltage difference between the gate electrode and the cathode electrode is varied by changing a voltage level applied to the gate electrode and the cathode electrode. Referring to FIGS. 1 and 8, in the electron emission display, the voltage level of the gate electrode, i.e., the voltage level of the scan signal and the voltage level of the cathode electrode, i.e., the voltage level of the data signal vary as the image level is changed. In more detail, as the image level increases from 52 to 250, that is, as the video data includes more high gradation data, the voltage level of the cathode electrode increases by ΔV3 and the voltage level of the gate electrode decreases by ΔV4. Then, the voltage difference between the gate electrode and the cathode electrode decreases, and thus the electron emission of each electron emission device decreases, thereby decreasing the brightness of each pixel. The other signals of FIG. 8 are not different from those of FIG. 6, and therefore repetitive descriptions will be avoided.

FIG. 9 is a flowchart of controlling the electron emission display according to an embodiment of the present invention.

Referring to FIG. 9, a method of controlling the electron emission display includes an operation S10 of determining an image level, and an operation S20 of adjusting the voltage difference between the gate electrode and the cathode electrode of the electron emission device on the basis of the measured image level.

In the operation S10 of determining the image level, the image level is determined corresponding to the video data of one frame. Preferably, the image level is determined in a unit of one frame, but not limited to. Alternatively, the image level may be determined in a unit of a plurality of frames. For example, the operation S10 includes an operation S11 of obtaining a sum of the video data of one frame, and an operation S12 of outputting an upper k-bit of the obtained sum as the image level (where, k is an integer not less than 2). As the bit (k) of the image level gets higher, the voltage difference between the gate electrode and the cathode electrode is more precisely adjusted.

In the operation of adjusting the voltage difference between the gate electrode and the cathode electrode, the voltage difference between the cathode electrode and the gate electrode of the electron emission device is adjusted corresponding to the image level. In the case that the image level is low, the voltage difference between the cathode electrode and the gate electrode of the electron emission device is adjusted to become high. Contrarily, in the case that the image level is high, the voltage difference between the cathode electrode and the gate electrode of the electron emission device is adjusted to become low. Here, the low image level means the video data includes much low gradation data, and it does not necessarily mean that a number indicating the determined image level is low. For example, the operation S20 includes an operation S21 of applying a power having a voltage level corresponding to the determined image level to at least one of the data driver and the scan driver, and an operation S22 of allowing at least one of the data driver and the scan driver to adjust the voltage difference between the cathode electrode and the gate electrode of the electron emission device on the basis of the applied voltage level.

In the method of controlling the electron emission display, each operation can be easily appreciated with reference to the foregoing embodiments of the electron emission display, so that repetitive descriptions will be avoided for the sake of convenience.

The present invention can also be realized as computer-executable instructions in computer_readable media. The computer_readable media includes all possible kinds of media in which computer_readable data is stored or included or can include any type of data that can be read by a computer or a processing unit. The computer_readable media include for example and not limited to storing media, such as magnetic storing media (e.g., ROMs, floppy disks, hard disk, and the like), optical reading media (e.g., CD_ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer_readable media can store and execute computer_readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

An example of a computer, but not limited to this example of the computer, that can read computer readable media that includes computer-executable instructions of the present invention includes a processor that controls the computer. The processor uses the system memory and a computer readable memory device that includes certain computer readable recording media. A system bus connects the processor to a network interface, modem or other interface that accommodates a connection to another computer or network such as the Internet. The system bus may also include an input and output interface that accommodates connection to a variety of other devices.

As described above, the present invention provides an electron emission display and a method of controlling the same, in which a voltage applied to a cathode electrode and a gate electrode is adjusted according to an image level, so that a contrast of an image is high in the case of a low image level and a power consumption is limited in the case of a high image level, and an electron emission device is prevented from deterioration.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An electron emission display comprising:
a pixel portion comprising a plurality of electron emission devices formed adjacent to a region where a plurality of data lines intersects a plurality of scan lines;
a data driver supplying a data signal corresponding to video data to said plurality of data lines;
a scan driver supplying scan signals to said plurality of scan lines in sequence;
a power supply supplying power to said data driver and said scan driver; and
a voltage level controller controlling a voltage difference between a cathode electrode and a gate electrode of the electron emission device on the basis of an image level corresponding to the video data.

2. The electron emission display according to claim 1, wherein the voltage difference is controlled by varying a voltage level applied to said cathode electrode on the basis of the image level.

3. The electron emission display according to claim 1, wherein the voltage difference is controlled by varying a voltage level applied to said gate electrode according to the image level.

4. The electron emission display according to claim 1, wherein the voltage difference is controlled by varying voltage levels applied to said cathode and gate electrodes according to the image level.

5. The electron emission display according to claim 1, wherein the voltage difference becomes lower as the image level gets higher.

6. The electron emission display according to claim 1, wherein said voltage level controller controls the power supplied from said power supply to have a voltage level corresponding to the image level, and at least one of said data driver and said scan driver varies the voltage level of the data signal or the scan signal or both the data signal and the scan signal on the basis of the voltage variation of the supplied power.

7. The electron emission display according to claim 1, wherein said data driver supplies the data signal allowing an electron emission period of the electron emission device to be determined corresponding the video data.

8. The electron emission display according to claim 1, wherein the data signal is obtained by applying a pulse width modulation to the video data.

9. The electron emission display according to claim 1, wherein the data line corresponds to said cathode electrode, and the scan line corresponds to the gate electrode.

10. The electron emission display according to claim 1, wherein the data line corresponds to said gate electrode, and the scan line corresponds to said cathode electrode.

11. An electron emission display comprising:
a pixel portion comprising a plurality of electron emission devices defined by a plurality of data lines and a plurality of scan lines;
a data driver supplying a data signal corresponding to video data to said plurality of data lines;
a scan driver supplying scan signals to the plurality of scan lines in sequence;
a power supply supplying powers to said data driver and said scan driver; and
a voltage level controller controlling a voltage level of the power supplied from said power supply to at least one of said data driver and said scan driver to be varied on the basis of an image level of the video data.

12. The electron emission display according to claim 11, wherein said voltage level controller determines the image level on the basis of the video data corresponding to one frame.

13. The electron emission display according to claim 11, wherein said voltage level controller comprises:
an image level determiner to obtain the image level based on a sum of the video data corresponding to one frame; and
a voltage level determiner to control said power supply in correspondence to the obtained image.

14. The electron emission display according to claim 13, wherein the image level is an upper k-bit of the sum of the video data corresponding to one frame,where k is an integer of at least 2).

15. The electron emission display according to claim 11, wherein said data driver adjusts a voltage level of the data signal on the basis of the power supplied from said power supply.

16. The electron emission display according to claim 11, wherein said data driver comprises:
a serial-parallel converter to convert the video data inputted in sequence into parallel video data;
a pulse width modulator to modulate a pulse width of the parallel video data; and
a level adjuster to adjust a voltage level of the data signal outputted from said pulse width modulator according to the power supplied from said power supply, and output the data signal having the adjusted voltage level to the data line.

17. The electron emission display according to claim 1, wherein said scan driver adjusts a voltage level of the scan signal on the basis of the power supplied from said power supply.

18. The electron emission display according to claim 11, wherein said scan driver comprises:
a shift register to output the scan signals in sequence; and
a level adjuster to adjust a voltage level of the scan signal outputted from said shift register on the basis of the power supplied from said power supply, and output the scan signal having the adjusted voltage level to the scan line.

19. A method of controlling an electron emission display, comprising:
determining an image level of video data; and
adjusting a voltage difference between a cathode electrode and a gate electrode of an electron emission device on the basis of an image level.

20. The method according to claim 19, wherein the determining of the image level of video data comprises:
obtaining a sum of the video data corresponding to one frame; and
outputting an upper k-bit of the obtained sum as the image level,where k is an integer of at least 2.

21. The method according to claim 19, wherein the adjusting of the voltage difference between said cathode electrode and said gate electrode of an electron emission device on the basis of the image level comprises:
supplying power having a voltage level corresponding to the image level to at least one of a data driver and a scan driver; and
allowing at least one of said data driver and said scan driver to adjust the voltage difference on the basis of the supplied power.

22. The method according to claim 19, wherein the voltage difference is a first voltage difference when the image level is a first image level, and the voltage difference is a second voltage difference when the image level is a second image level, where the first voltage is greater than the second voltage difference and the first image level is less than the second image level.

23. The method according to claim 19, wherein the voltage difference is controlled by varying a voltage level applied to said cathode electrode on the basis of the image level.

24. The method according to claim 19, wherein the voltage difference is controlled by varying a voltage level applied to said gate electrode on the basis of the image level.

25. The method according to claim 19, wherein the voltage difference is controlled by varying voltage levels applied to said cathode and gate electrodes according to the image level.

26. The method according to claim 19, wherein one of a data signal and a scan signal is applied to said gate electrode, and the other one is applied to said cathode electrode.

27. The method according to claim 26, wherein the data signal is obtained by applying a pulse width modulation to the video data.

28. A computer-readable medium having computer-executable instructions for performing the method of claim 19.
